(19) United States
(12) Patent Application Publication
(10) Pub. No.: US 2013/0168517 A1
(43) Pub. Date: Jul. 4, 2013

(54) REINFORCED STRUCTURE FOR HOOKS

(71) Applicants: Hung-Wei Chu, Taipei City (TW); Man-Chu Wang, Yuanlin Township (TW)

(72) Inventors: Hung-Wei Chu, Taipei City (TW); Man-Chu Wang, Yuanlin Township (TW)

(21) Appl. No.: 13/730,510

(22) Filed: Dec. 28, 2012

(30) Foreign Application Priority Data
Dec. 30, 2011 (TW) 100225071

(51) Int. Cl. F16B 45/00

(52) U.S. Cl. CPC F16B 45/00
USPC 248/304

(57) ABSTRACT

A reinforced hook structure may include a hook body, having a back board which is a curved hook portion made in one piece, and a space is formed between the top portion of the hook portion and the back board to engage with a hanging unit. The front portion of the hook portion and the back board has some reinforced ribs, while the inner portion of the hook portion and the back board has a reinforced section to enhance the structural strength between the hook portion and the back board. When the hanging portion wedges in the hanging unit to hang subjects, the hanging portion has to sustain the weight of the subject and the hanging unit and when the hanging portion is weaker, it may be bended or broken.

### FIELD OF THE INVENTION

The present invention relates to a hook structure, and more particularly to a reinforced hook structure to enhance the structural strength of between a hook portion and back board to increase the life of the hook structure.

### BACKGROUND OF THE INVENTION

Referring to FIGS. 13 and 14, a conventional hook structure has a base (30), having a lateral surface on one side to attach to a wall surface or a flat surface. The other side of the base (30) has a hanging portion (31) made in one piece. A spacing (32) is located between the top portion of the hanging portion (31) and the base (30), and a hanging unit (33) is wedged in to form a secure positioning, as well as one horizontal rod body (331). When the hanging unit (33) is wedged into the hanging portion (31) through the rod body (331), the hanging unit (33) cannot be separated and the hanging unit (33) can be used as a hanger. However, the hanging portion (31) extends from the base (30) due to limited thickness, and the rod body (331) of the hanging unit (33) is usually larger than the hanging portion (31). When the hanging portion (31) wedges in the hanging unit (33) to hang subjects, the hanging portion (31) has to sustain the weight of the subject and the hanging unit (33) and when the hanging portion (31) is weaker, it may be bended or broken.

### SUMMARY OF THE INVENTION

The technical problem the present invention wants to solve is that the hanging portion extends from the base due to limited thickness, and the rod body of the hanging unit is usually larger than the hanging portion. When the hanging portion wedges in the hanging unit to hang subjects, the hanging portion has to sustain the weight of the subject and the hanging unit and when the hanging portion is weaker, it may be bended or broken.

To solve the problem mentioned above, the present invention provides a reinforced hook structure including a hook body, having a back board which is a curved hook portion made in one piece, and a space is formed between the top portion of the hook portion and the back board to engage with a hanging unit. The front portion of the hook portion and the back board has some reinforced ribs, while the inner portion of the hook portion and the back board has a reinforced section to enhance the structural strength between the hook portion and the back board.

Comparing with conventional hook structure, the present invention is advantageous because the front portion and inner portion of the hook portion have reinforced ribs and reinforced section respectively to enhance the structural strength between the hook portion and the back board, so as to enable the hook body to engage with the hanging unit through the hook portion. When the hanging unit is used, it can sustain more stress to avoid the hook portion being bended and broken, and further increase the life of the hook.

### BRIEF DESCRIPTION OF THE DRAWINGS

FIG. 1 illustrates a three-dimensional view in the present invention.

FIG. 2 illustrates a sectional view of the present invention.

FIG. 3 illustrates a three-dimensional view of one embodiment of the present invention.

FIG. 4 illustrates a sectional view of one embodiment of the present invention.

FIG. 5 illustrates a schematic view of the present invention.

FIG. 6 illustrates one embodiment of using the hook structure of the present invention.

FIG. 7 illustrates another embodiment of using the hook structure of the present invention.

FIG. 8 illustrates another embodiment of using the hook structure of the present invention.

FIG. 9 illustrates a further embodiment of using the hook structure of the present invention.

FIG. 10 illustrates a further embodiment of using the hook structure of the present invention.

FIG. 11 illustrates an exemplary embodiment of using the hook structure of the present invention.

FIG. 12 illustrates an exemplary embodiment of using the hook structure of the present invention.

FIG. 13 illustrates an exploded view of a conventional hook structure.

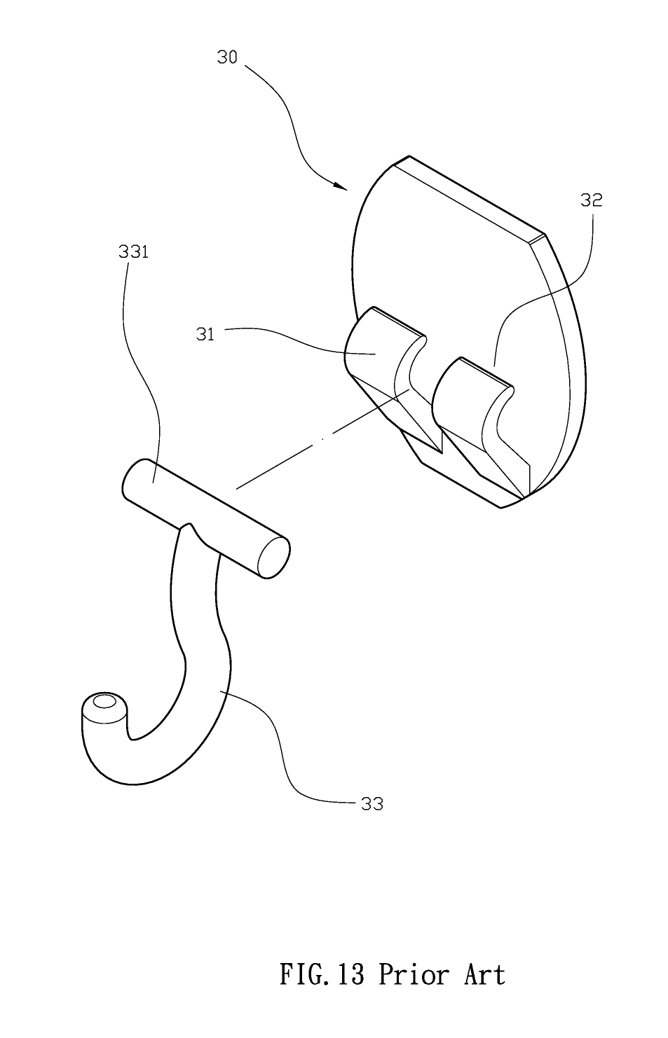

FIG. 14 illustrates a sectional view of a conventional hook structure.

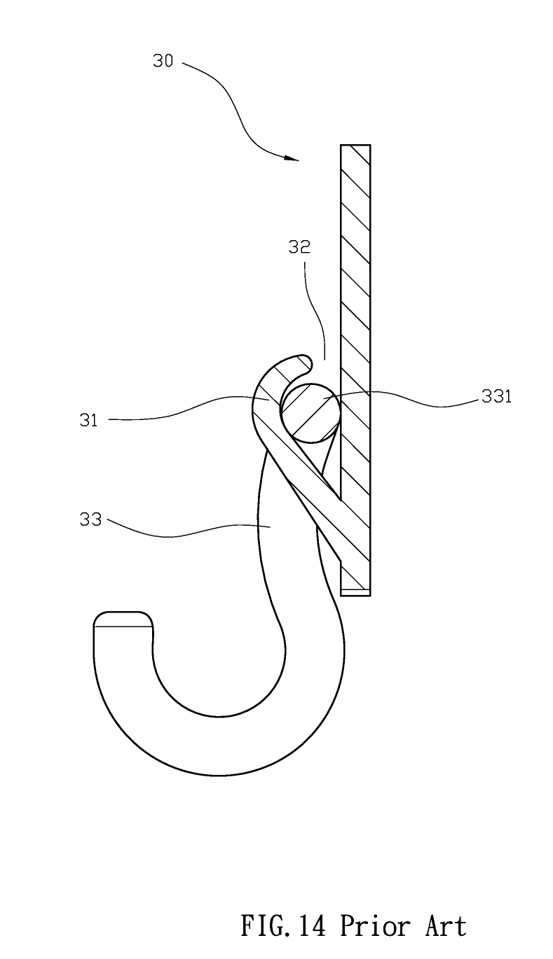

FIG. 15 illustrates one embodiment of using a conventional hook structure.

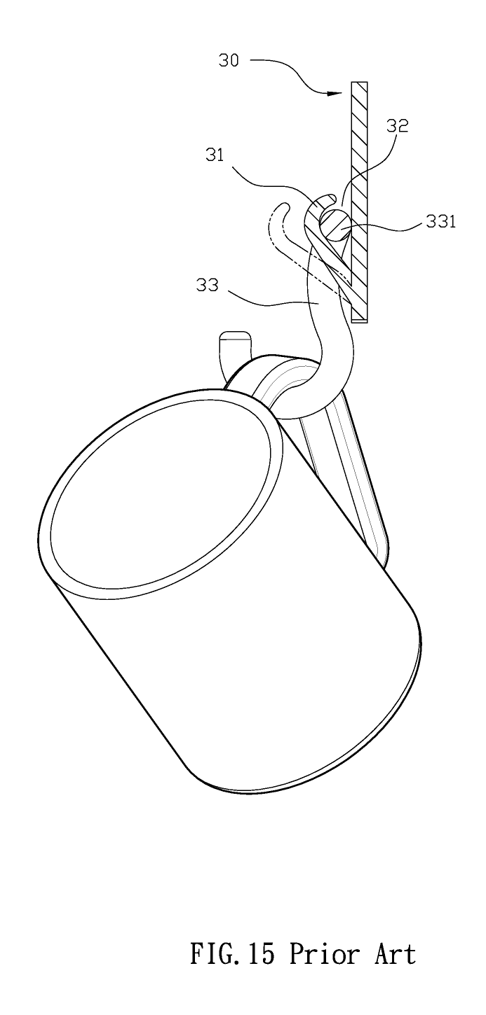

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

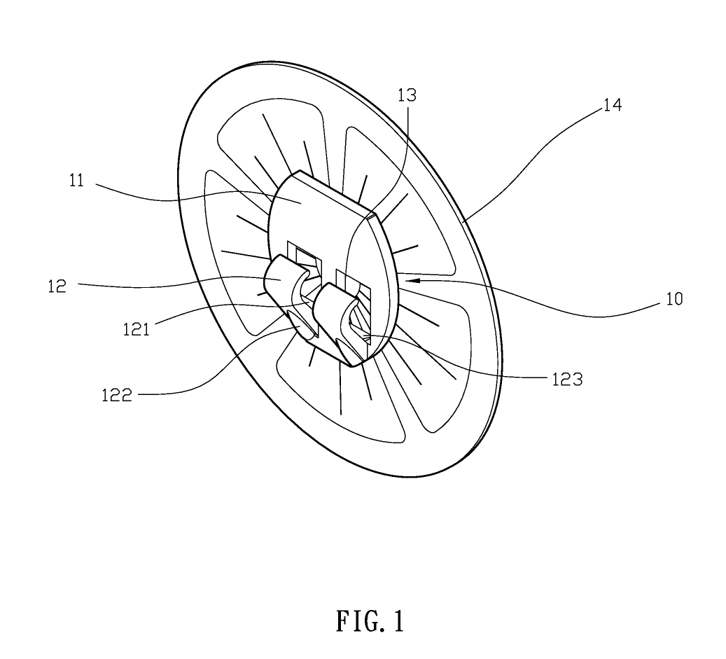

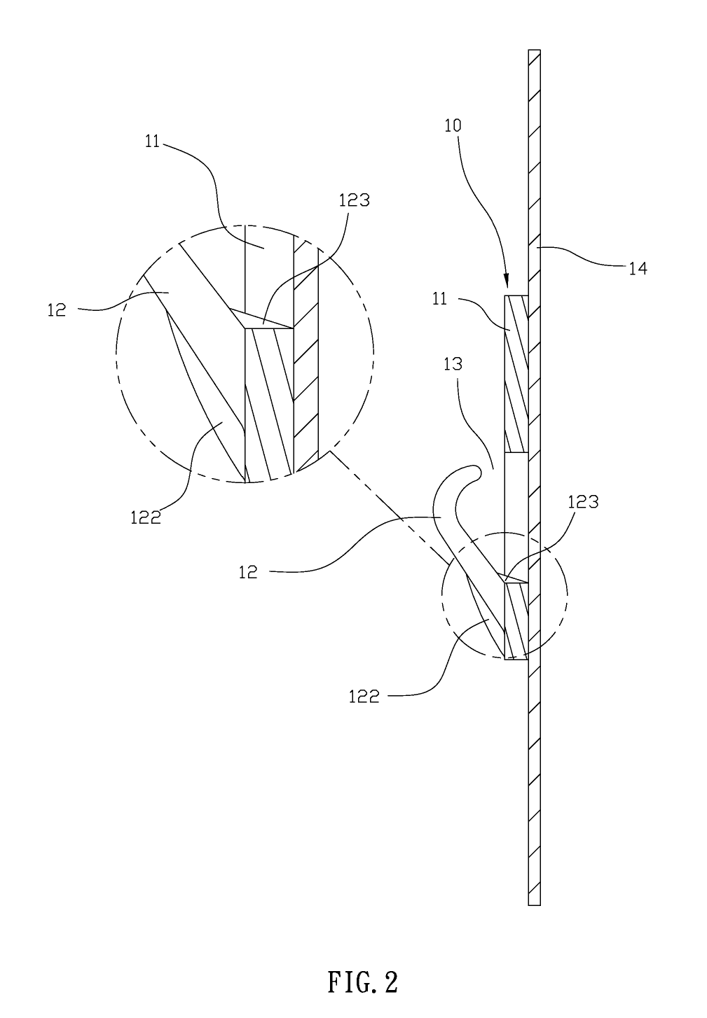

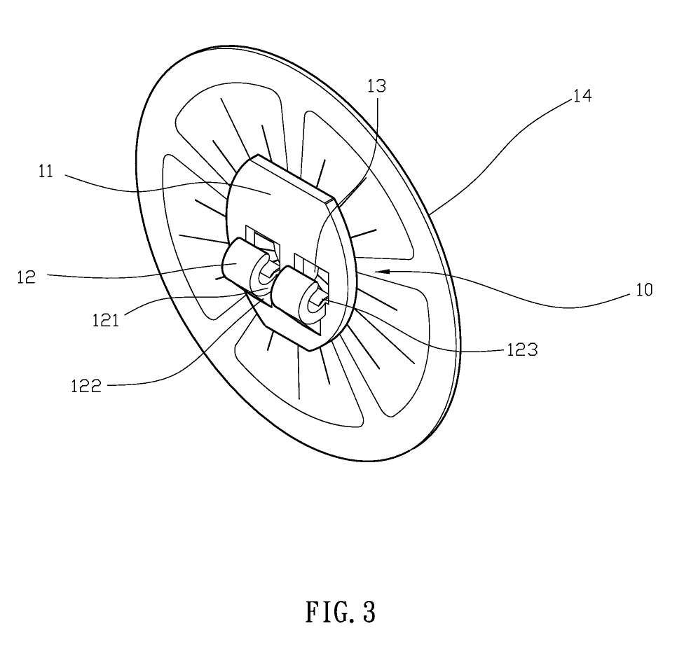

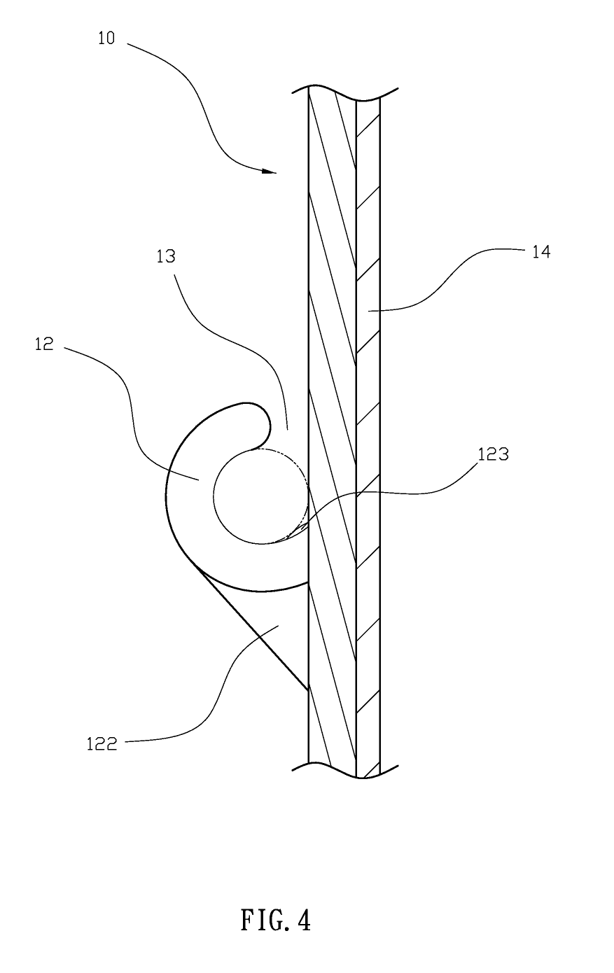

Referring to FIGS. 1 and 2, a reinforced hook structure may include a hook body (10), having a back board (11) which is a curved hook portion (12) made in one piece, and a space (13) is formed between the top portion of the hook portion (12) and the back board (11) to engage with a hanging unit (20). The back board (11) of the hook body (10) can form a dual hook portion (12) made in one piece, and a gap (121) is located between said two hook portions (12). The front portion of the hook portion (12) and the back board (11) has some reinforced ribs (122), while the inner portion of the hook portion (12) and the back board (11) has a reinforced section (123). FIGS. 3 and 4 show another embodiment of the present invention. According to the structure mentioned above, the structural strength between the back board (11) of the hook body (10) and the hook portion (12) can be increased to improve the practicability when in use.

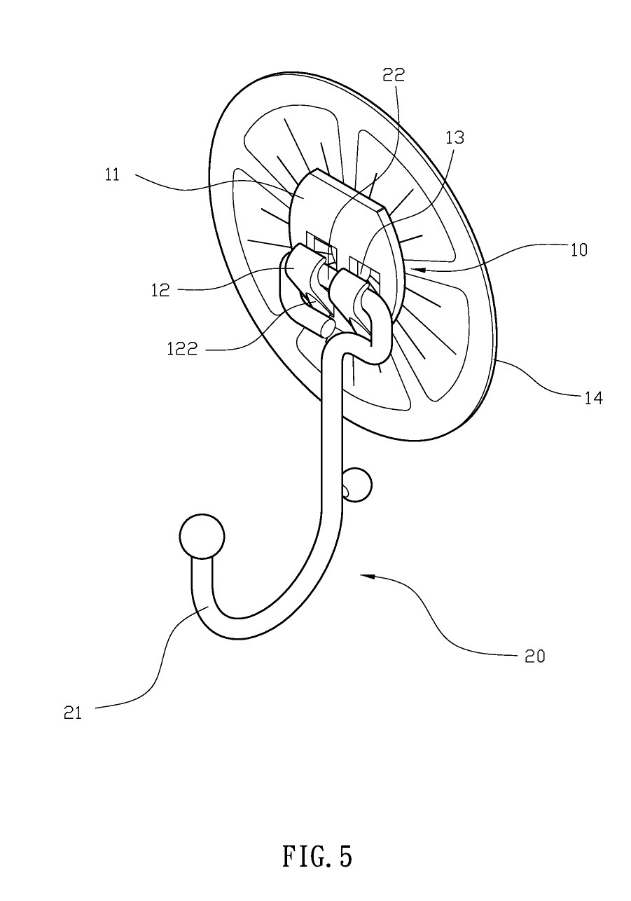

Referring to FIG. 5, a sticky layer (14) is on the back side of the back board (11) of the hook body (10) to attach the hook on a wall surface or a flat surface. The hook can be attached to the wall by nails or other locking units. The hanging unit (20) has a curved hanging portion (21), and a rod (22) extending horizontally from the top portion of the hanging unit (20) engages with the hook portion (12) to be securely positioned. The radius of the rod (22) is slightly larger than the space (13) between the top portion of the hook portion (12) and the back board (11), so that the hanging unit (20) can be press into the space to be securely positioned, and the user can use the hanging portion (21) of the hanging unit (20) for clothes, cups, etc.

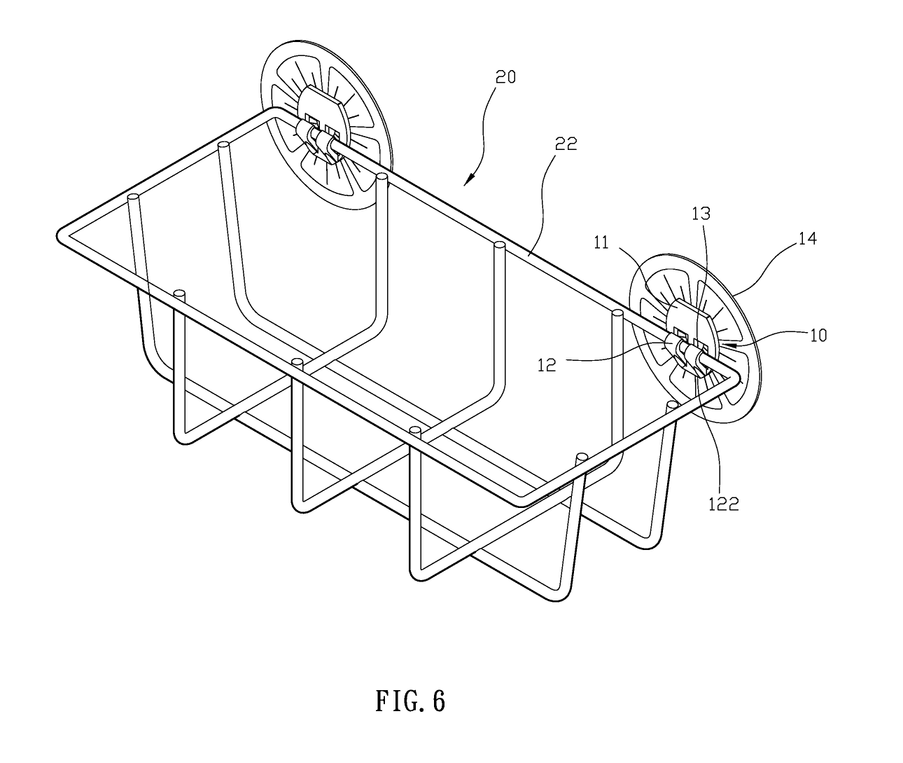

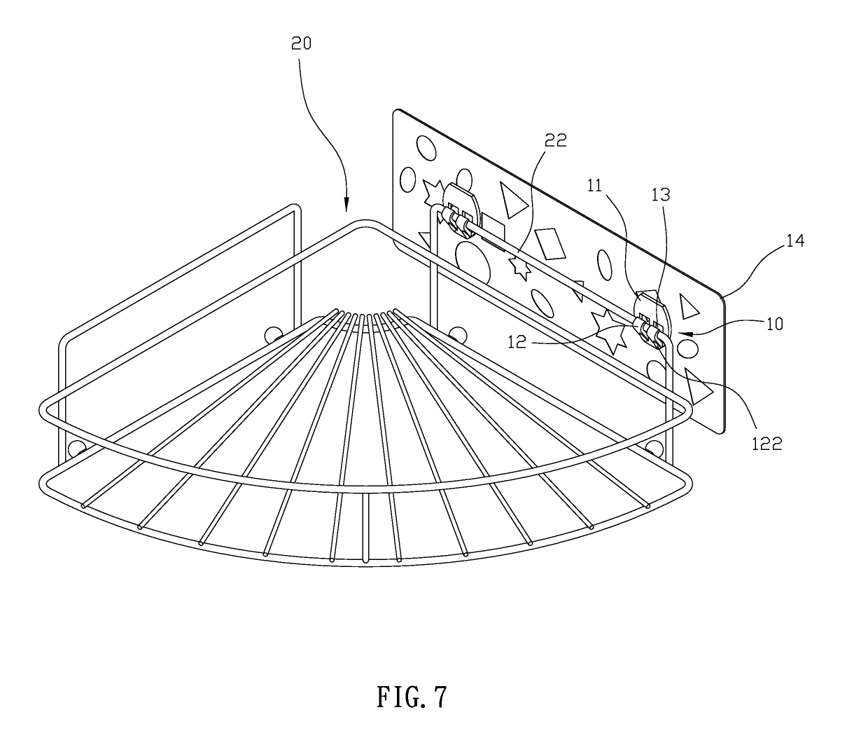

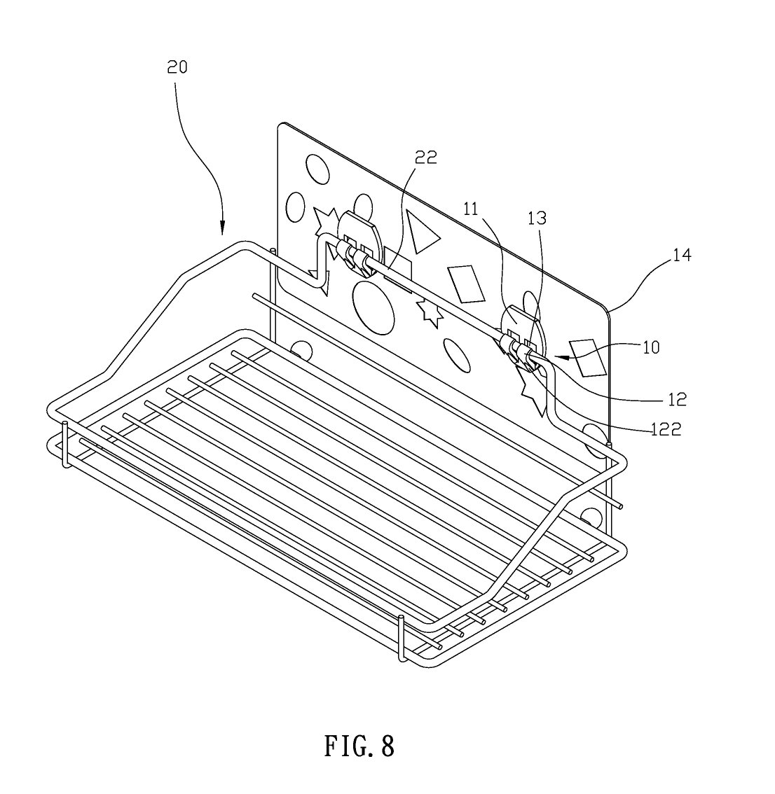

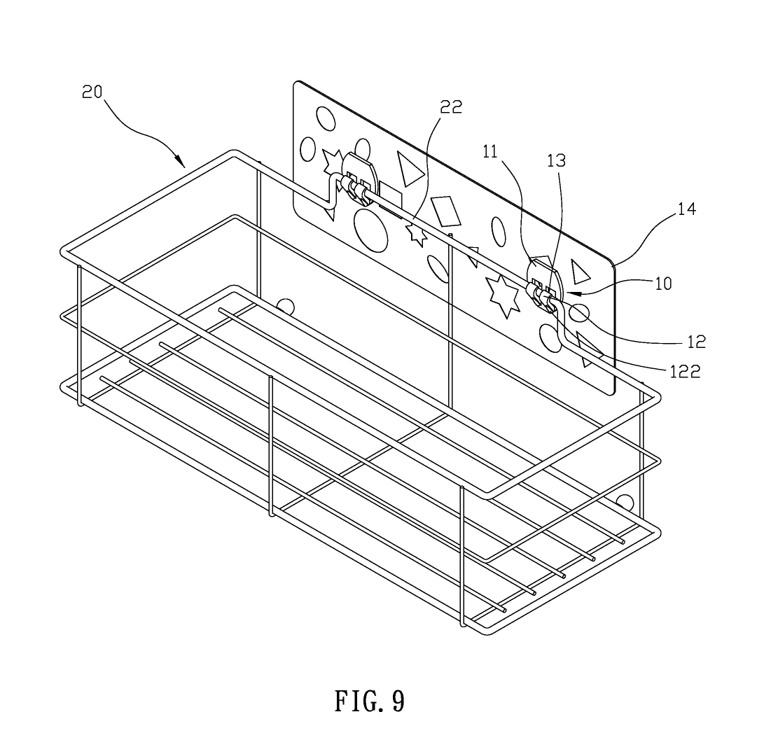

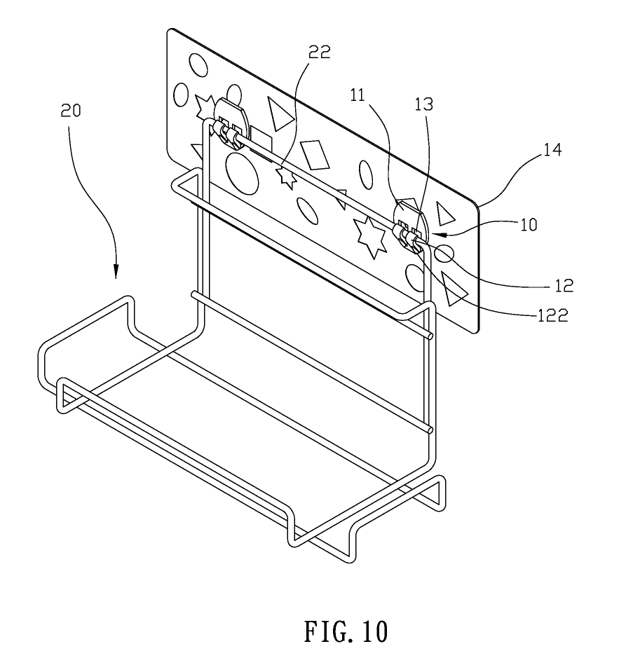

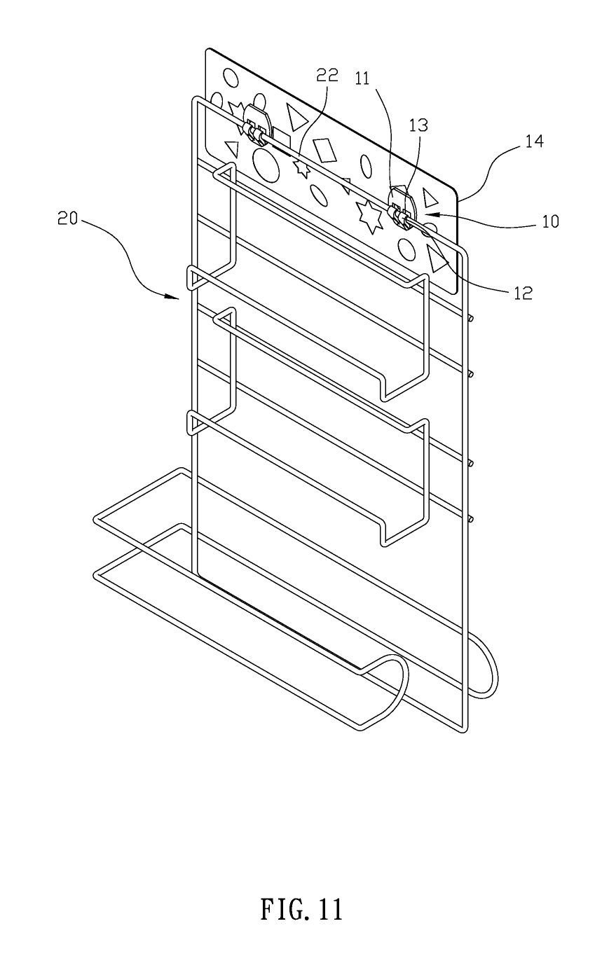

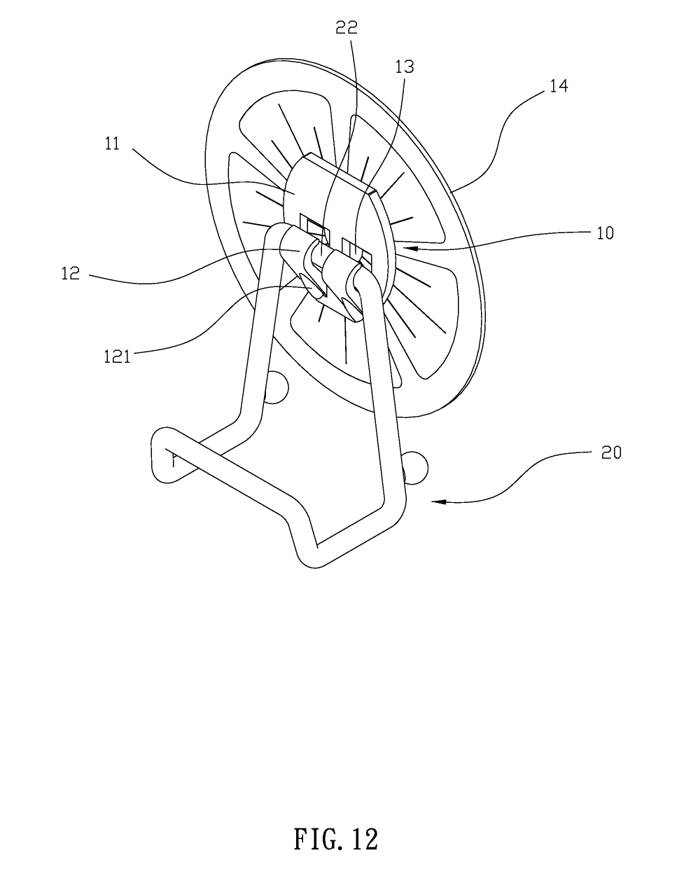

Referring to FIGS. 6 to 12, the hanging unit (20) can be a hanger or basket, and the rod (22) extending horizontally passes through the hanger or basket and secures inside the hook portion (12). The radius of the rod (22) is slightly larger than the space (13) between the top portion of the hook portion (12) and the back board (11), so that the hanging unit (20) can be press into the space to be securely positioned, and the hanger or basket can be disposed thereon.

According to the embodiments illustrated above, the present invention is advantageous because the front portion and inner portion of the hook portion (12) have reinforced ribs (122) and reinforced section (123) respectively to enhance the structural strength between the hook portion (12) and the back board (11), so as to enable the hook body (10) to engage with the hanging unit (20) through the hook portion (12). When the hanging unit (20) is used, it can sustain more stress to avoid the hook portion (12) being bended and broken, and further increase the life of the hook.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A reinforced hook structure comprising:
a hook body, having a back board which is a curved hook portion made in one piece; a space formed between top portion of the hook portion and the back board to engage with a hanging unit, wherein front portion of the hook portion and the back board has reinforced ribs, and inner portion of the hook portion and the back board has a reinforced section to enhance the structural strength between the hook portion and the back board.

2. The reinforced hook structure of claim 1, wherein a dual hook portion made in one piece is formed at the back board of the hook body, and a gap is located therebetween.

3. The reinforced hook structure of claim 1, wherein the hanging unit has a curved hanging portion, and a rod extending horizontally from the top portion of the hanging unit engages with the hook portion to be securely positioned.

4. The reinforced hook structure of claim 2, wherein the hanging unit has a curved hanging portion, and a rod extending horizontally from the top portion of the hanging unit engages with the hook portion to be securely positioned.

5. The reinforced hook structure of claim 3, wherein the radius of the rod is slightly larger than the space between the top portion of the hook portion and the back board.

6. The reinforced hook structure of claim 4, wherein the radius of the rod is slightly larger than the space between the top portion of the hook portion and the back board.

7. The reinforced hook structure of claim 1, wherein the hanging unit is a hanger, basket or the like, and the rod extending horizontally passes through the hanger or basket and secures inside the hook portion.

8. The reinforced hook structure of claim 2, wherein the hanging unit is a hanger, basket or the like, and the rod extending horizontally passes through the hanger or basket and secures inside the hook portion.

9. The reinforced hook structure of claim 7, wherein the radius of the rod is slightly larger than the space between the top portion of the hook portion and the back board.

10. The reinforced hook structure of claim 8, wherein the radius of the rod is slightly larger than the space between the top portion of the hook portion and the back board.

11. The reinforced hook structure of claim 1, wherein a sticky layer is disposed on the back side of the back board of the hook body to attach the hook body on a wall surface or a flat surface.

12. The reinforced hook structure of claim 2, wherein a sticky layer is disposed on the back side of the back board of the hook body to attach the hook body on a wall surface or a flat surface.

13. The reinforced hook structure of claim 1, wherein when the hook body is attached to a wall or flat surface, a nail or locking unit is used to secure the hook body to the surface.

14. The reinforced hook structure of claim 2, wherein when the hook body is attached to a wall or flat surface, a nail or locking unit is used to secure the hook body to the surface.
